(19) United States
(12) Patent Application Publication
(10) Pub. No.: US 2007/0121981 A1
(43) Pub. Date: May 31, 2007

(54) PORTABLE SPEAKER OF PORTABLE MULTIMEDIA DEVICE

(76) Inventors: You-kyung Koh, Seoul (KR); Noh-byung Park, Yongin-si (KR); Young-suk Song, Suwon-si (KR)

Correspondence Address: STANZIONE & KIM, LLP, 919 18TH STREET, N.W., SUITE 440, WASHINGTON, DC, 20006, US

(21) Appl. No.: 11/468,047

(22) Filed: Aug. 29, 2006

(30) Foreign Application Priority Data
Nov. 26, 2005 (KR) 2005-113861

(51) Int. Cl. H04R 1/02; H04R 9/06

(52) U.S. Cl. 381/334

(57) ABSTRACT

A portable speaker of a portable multimedia device includes a digital amplifier to receive a digital audio signal from the portable multimedia device and to digitally process and output the received digital audio signal to a speaker unit, and a battery to supply electric power to at least one of the digital amplifier and the portable multimedia device.

### CROSS-REFERENCE TO RELATED APPLICATIONS

This application claims priority under 35 U.S.C. §119(a) from Korean Patent Application No. 10-2005-0113861, filed on Nov. 26, 2005, in the Korean Intellectual Property Office, the disclosure of which is incorporated herein in its entirety by reference.

### BACKGROUND OF THE INVENTION

1. Field of the Invention

The present general inventive concept relates to a portable speaker of a portable multimedia device.

2. Description of the Related Art

As a variety of portable multimedia devices are being commercialized and developed, users can enjoy a variety of multimedia anywhere and at anytime.

In order to listen to a music or audio signal of a movie from a conventional multimedia device, a user generally uses an earphone or a built-in speaker of the multimedia device.

For example, as illustrated in FIG. 1A, an audio signal may be output through a built-in speaker 110 of a portable multimedia device 100.

Alternatively, as illustrated in FIG. 1B, the audio signal may be output through an earphone 120 connected to the portable multimedia device 100.

As described above, since a user listens to the sound from the portable multimedia device 100 through the earphone 120 or built-in speaker 110, the user cannot enjoy a high-quality sound, a space feeling, or a virtualizer effect (e.g., a surround-sound effect).

Also, when a user uses the portable multimedia device 100 at an outdoor site for a long period of time, and thus an internal battery thereof becomes fully discharged, the user cannot use the portable multimedia device 100 until the internal battery is recharged or replaced with a new battery resulting in an inconvenience to the user.

As described above, one of the drawbacks of a portable multimedia device, such as an MP3 player or a portable multimedia player (PMP), is that the device has only an earphone output without a speaker output. Even when the portable multimedia device has a built-in speaker system, the performance of the speaker system is very low. It is very difficult to install a high quality audio amplifier or speaker unit in a limited space of the portable multimedia device that is minimized in size and has a variety of functions. Therefore, a low quality audio amplifier or speaker unit that can be designed to have a relatively small size is applied to the portable multimedia device. Thus, many built-in speakers applied to portable multimedia devices output a mono-sound. On the other hand, when a built-in speaker outputs a stereo-sound, an internal battery thereof is quickly discharged due to a low performance of the built-in stereo-sound speaker.

Therefore, there is a need for a portable speaker that can be used when a user wishes to enjoy a high quality sound from a multimedia device and can function as an external battery pack for the multimedia device.

### SUMMARY OF THE INVENTION

The present general inventive concept provides a portable speaker to output a high quality sound signal including a variety of three-dimensional sound signals from a portable multimedia device.

The present general inventive concept also provides a portable speaker to function as an external battery pack to supply electric power to the multimedia device.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a portable speaker of a portable multimedia device, including a digital amplifier to receive a digital audio signal from the portable multimedia device and to digitally process and output the received digital audio signal to a speaker unit, and a battery to supply electric power to at least one of the digital amplifier and the portable multimedia device.

The battery may always supply the electric power to the portable multimedia device when the portable speaker is connected to the portable multimedia device.

The battery may supply the electric power to the portable multimedia device only when an internal battery of the portable multimedia device is fully discharged and the portable speaker is connected to the portable multimedia device.

The portable speaker may further include a virtualizer to provide a sound field effect to the audio signal, and a dynamic range controller to prevent a clipping of the audio signal.

The foregoing and/or other aspects and utilities of the present general inventive concept may also be achieved by providing a portable speaker unit useable with a multimedia device, including a processing unit to process a digital audio signal received from the multimedia device and to output an audio analog signal corresponding to the received digital audio signal, at least one speaker to receive the audio analog signal from the processing unit and to output sound corresponding to the audio analog signal, and a battery unit to supply electric power to at least one of the processing unit and the multimedia device.

The processing unit may include a virtualizer unit to provide a sound field effect to the digital audio signal received from the multimedia device and to output the digital audio signal having the sound field effect, a dynamic range controller unit to receive the digital audio signal having the sound field effect output from the virtualizer, to control a dynamic range of the digital audio signal having the sound field effect to prevent the signal from clipping, and to output a digital output signal, and a digital amplifier unit to receive the digital output signal output from the dynamic range controller, and to output a demodulated audio analog signal to the at least one speaker.

The digital amplifier unit may convert the digital output signal received from the dynamic range controller into a pulse width modulation signal, may amplify the pulse width modulation signal to generate an audio analog signal, may demodulate the audio analog signal, and may output the demodulated audio analog signal to the at least one speaker.

The digital amplifier unit may include a converter to convert the received digital output signal into the pulse width modulation signal and to output the pulse width modulation signal, a switching unit to receive the pulse width modulation signal output from the converter, to amplify the pulse width modulation signal to generate the audio analog signal, and to output the audio analog signal, and a filter to receive the audio analog signal output from the switching unit, to demodulate the audio analog signal, and to output the demodulated audio analog signal to the at least one speaker.

The digital output signal output from the dynamic range controller may include a pulse code modulation signal having a low amplitude. The digital amplifier unit may include an integrated circuit chip. The switching unit may include a field effect transistor. The battery unit may provide power to the switching unit.

The portable speaker unit may further include at least one connecting unit to transmit the digital audio signal from the multimedia device to the portable speaker unit. The connecting unit may include at least one of a connecting jack and a connecting dock. The portable speaker unit may further include at least one connecting unit to supply the electric power from the portable speaker unit to the multimedia device. The connecting unit may include negative and positive poles and a ground unit to supply the electric power from the portable speaker unit to the multimedia device. The portable speaker unit may further include a multi-channel interface unit to transmit the digital audio signal from the multimedia device to the portable speaker unit and to supply the electric power from the portable speaker unit to the multimedia device. The multi-channel interface unit may include a signal transmission pin to transmit the digital audio signal from the multimedia device to the portable speaker unit, and a power transmission pin to supply the electric power from the portable speaker unit to the multimedia device.

The foregoing and/or other aspects and utilities of the present general inventive concept may also be achieved by providing a portable multimedia apparatus, including a multimedia unit including a signal generating unit to decode audio data and to output a digital audio signal corresponding to the decoded audio data and an internal battery to provide electric power to the signal generating unit, and a removable portable speaker unit including a processing unit to process the digital audio signal output from the signal generating unit and to output an audio analog signal corresponding to the digital audio signal, at least one speaker to receive the audio analog signal output from the processing unit and to output sound corresponding to the audio analog signal, and a battery unit to supply electric power to at least one of the processing unit and the signal generating unit.

The portable multimedia apparatus may further include a multi-channel interface unit to transmit the digital audio signal from the signal generating unit to the processing unit and to supply the electric power from the battery unit to the signal generating unit.

The foregoing and/or other aspects and utilities of the present general inventive concept may also be achieved by providing a portable multimedia apparatus, including a multimedia device including a signal generating unit to decode audio data and to output a digital audio signal corresponding to the decoded audio data and an internal battery to supply electric power to the signal generating unit, and an external battery pack to supply electric power to the portable multimedia device including at least one speaker to output sound corresponding to the digital analog signal output from the signal generating unit and a battery unit to supply electric power to the signal generating unit of the portable multimedia device.

The internal battery may supply the electric power to the signal generating unit until the internal battery is discharged, and then the battery unit may supply the electric power to the portable multimedia device thereafter. The portable multimedia apparatus may further include a multi-channel interface unit to transmit the digital audio signal from the portable multimedia device to the external battery pack and to supply the electric power from the external battery pack to the portable multimedia device. The external battery pack may recharge the internal battery by transmitting electric power thereto.

The foregoing and/or other aspects and utilities of the present general inventive concept may also be achieved by providing a method of providing electric power to a portable multimedia device, including supplying the electric power to the portable multimedia device from an internal battery thereof while the internal battery contains a charge, and supplying the electric power to the portable multimedia device from a portable external speaker based on the charge remaining in the internal battery. The method may further include recharging the internal battery of the portable multimedia device by providing electric power from the portable external speaker. The method may further include supplying the electric power to the portable multimedia device from a portable external speaker while maintaining a charge of an internal battery of the portable multimedia device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a view illustrating an audio signal output through a built-in speaker of a conventional portable multimedia device;

FIG. 1B is a view illustrating the audio signal output through an earphone connected to the conventional portable multimedia device of FIG. 1A;

FIG. 2 is a view illustrating a portable multimedia device that is associated with a portable speaker, according to an embodiment of the present general inventive concept;

FIG. 3 is a block diagram illustrating the portable speaker of FIG. 2, according to an embodiment of the present general inventive concept; and

FIG. 4 is a schematic view illustrating a docking jack of the portable speaker illustrated in FIG. 3, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

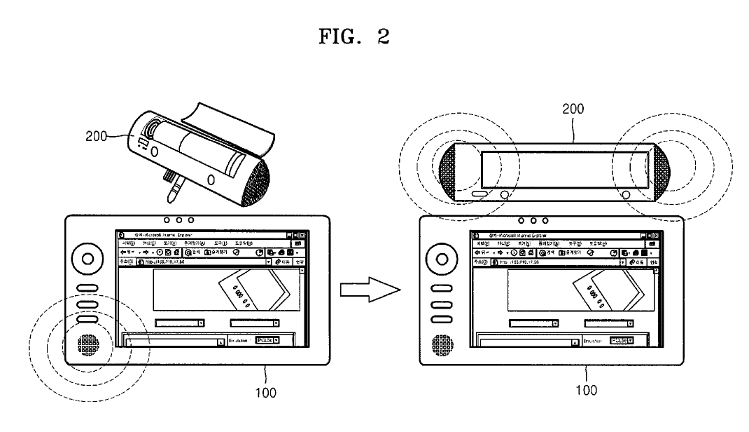

FIG. 2 is a view illustrating a portable multimedia device that is associated with a portable speaker, according to an embodiment of the present general inventive concept.

Referring to FIG. 2, a portable speaker 200 is connected to a portable multimedia device 100.

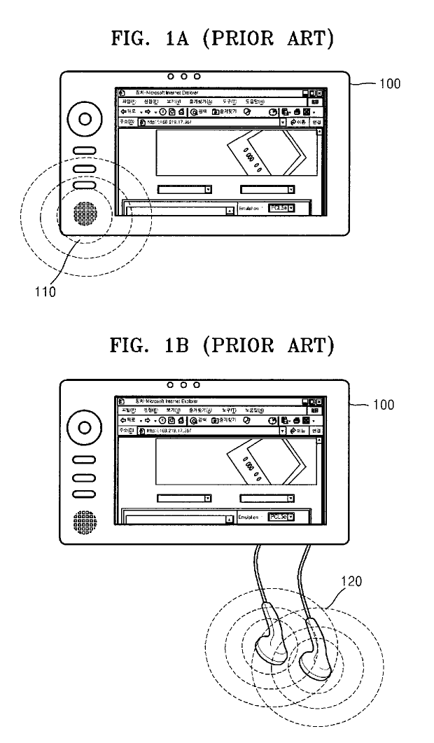

When the portable multimedia device 100 transmits left and right audio signals to the portable speaker 200 through a connector, such as a stereo jack, the portable speaker 200 digitally processes and outputs the left and right sound signals. The portable speaker 200 employs a high performance/high output digital amplifier to improve a sound quality as compared with a conventional built-in speaker of a conventional portable multimedia device (such as the built-in speaker 110 of the portable multimedia device 100 illustrated in FIG. 1).

The portable speaker 200 is designed to accommodate a battery therein to function as an external battery pack to supply electric power to the portable multimedia device 100, such as when an internal battery of the portable multimedia device 100 is fully discharged.

The portable speaker 200 may be connected to the portable multimedia device 100 through a variety of connectors, such as a stereo jack, a universal jack, or a dedicated dock to transmit the audio signals from the portable speaker 200 to the portable multimedia device 100.

A connector having negative and positive poles and a ground may be used to supply the electric power from the speaker 200 to the portable multimedia device 200.

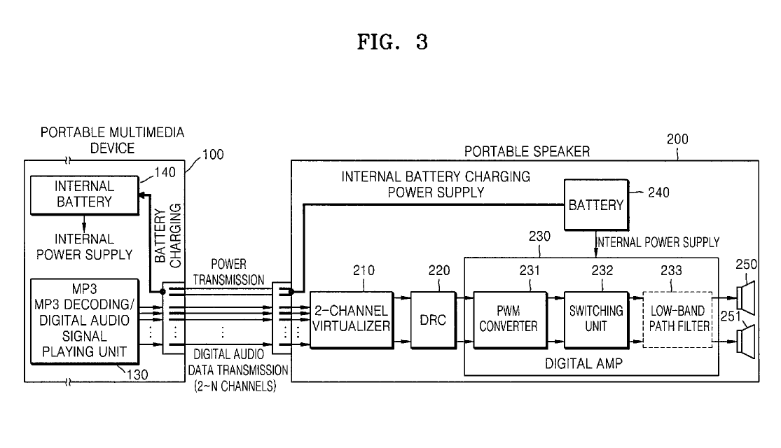

FIG. 3 is a view illustrating the portable speaker 200 of FIG. 2, according to an embodiment of the present general inventive concept.

Referring to FIG. 3, the portable speaker 200 may include a two-channel virtualizer 210, a dynamic range controller (DRC) 220, a digital amplifier 230, a battery 240, and speaker units 250 and 251.

The two-channel virtualizer 210 receives a digital audio signal from the portable multimedia device 100, provides a sound field effect to the received digital audio signal, and outputs the digital audio signal provided with the sound field effect to the DRC 220.

The DRC 220 controls a dynamic range of the digital audio signal to prevent the signal from clipping in the digital amplifier 230 when the digital audio signal output from the two-channel virtualizer 210 is too high. The DRC 220 also outputs an output signal to the digital amplifier 230.

The digital amplifier 230 may include a pulse width modulation (PWM) converter 231, a switching unit 232, and a low-band path filter 233.

The digital amplifier 230 converts a digital input signal, such as a pulse code modulation (PCM) signal having a low amplitude, into a PWM signal, amplifies the PWM signal using an amplifying circuit having a semiconductor switching element 232, such as a field effect transistor (FET), and outputs an audio analog signal demodulated by the low-band path filter 233 to the speaker units 250 and 251. The operations of the digital amplifier 230 will be now described in more detail.

The PWM converter 231 converts the digital signal transmitted from the DRC 220 into the PWM signal and outputs the PWM signal to the switching unit 232.

The switching unit 232 amplifies the PWM signal by receiving electric power from the battery 240 and outputs the amplified PWM signal to the low-band path filter 233.

The low-band path filter 233 demodulates the amplified PWM signal received from the switching unit 232 into the audio analog signal and outputs the audio analog signal to the speaker units 250 and 251.

The speaker units 250 and 251 receive the analog signal from the low-band path filter to generate sound.

The digital amplifier 230 may be formed of, for example, an integrated circuit (IC) chip to reduce a size of the portable speaker.

The battery 240 supplies the electric power to the digital amplifier 230 as well as to the portable multimedia device 100. As the battery 240 can be installed in the portable speaker 200, the portable speaker 200 can function as an external battery pack to supply the electric power to the portable multimedia device 100 when an internal battery 140 of the portable multimedia device 100 is fully discharged.

In order to supply electric power from the portable speaker 200 to the portable multimedia device 100, a connector having a Vcc and ground GND may be used.

The portable speaker 200 may also include a mute function. The mute function may be turned on or off by a mute switch (not illustrated). In addition, a two-channel virtualizer function may be turned on or off by a switch.

Although FIG. 3 is a view illustrating a case where the electric power is always supplied from the portable speaker 200 to the portable multimedia device 100 (as opposed to an electric power being supplied from the internal battery 140 to the portable multimedia device 100), the electric power may be supplied from the portable speaker 200 to the multimedia device 100 only when the internal battery 140 of the portable multimedia device 100 is fully discharged. In other words, the electric power may be initially supplied by the portable speaker 200, even when the internal battery 140 of the portable multimedia device 100 is not fully discharged. Alternatively, the electric power may be initially supplied by the internal battery 140 of the portable multimedia device 100, and subsequently supplied by the portable speaker 200 when the internal battery 140 of the portable multimedia device 100 is fully discharged.

The portable multimedia device 100 may include an MP3 decoding/digital audio signal generating unit 130 as well as the internal battery 140. The MP3 decoding/digital audio signal playing unit 130 decodes MP3 data and plays the digital audio signal. The internal battery 140 supplies the electric power to the MP3 decoding/digital audio signal playing unit 130. The internal battery 140 is recharged by receiving recharging power transmitted from the portable speaker/battery charging unit 200.

When the portable multimedia device outputs 2-N digital audio signals, such as left and right signals or 5.1-channel signals, the portable speaker 200 receives the digital audio signals and outputs the sound through the speaker units 250 and 251. Since the portable speaker 200 employs the digital amplifier 230 having a high performance/high output and a size smaller than a typical analog amplifier, sound quality and output can be improved as compared with the conventional built-in speaker 110 of the portable multimedia device 100 of FIG. 1.

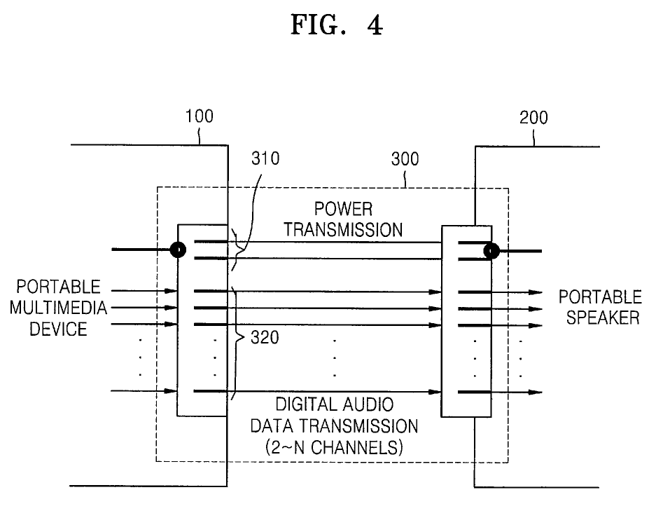

FIG. 4 is a view illustrating a docking jack 300 to connect the portable speaker 200 to the portable multimedia device 100.

Referring to FIG. 4, the docking jack 300 functions as a multi-channel interface that transmits the digital audio signal from the portable multimedia device 100 to the portable speaker 200 through a signal data transmission pin 320 and supplies the electric power from the battery 240 loaded in the portable speaker 200 to the portable multimedia device 100 through a power transmission pin 310 (e.g., to recharge the internal battery 140 of the portable multimedia device 100).

According to embodiments of the present general inventive concept, since a user listens to an audio signal that is not output from an earphone or a built-in speaker of a portable multimedia device, but from a portable speaker employing a high performance/high output digital amplifier, the user can enjoy a high quality sound.

Also, the user can carry the portable speaker employing a virtual technology, such as a virtual speaker/stereo dipole, and use the portable speaker by associating the same with the portable multimedia device.

Furthermore, when an internal battery of the portable multimedia device is fully discharged at a place where the internal battery cannot be recharged, electric power can be supplied from a battery loaded in the portable speaker to the portable multimedia device.

Also, since the portable speaker may include a DRC, clipping of the audio signal can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A portable speaker of a portable multimedia device, comprising:
a digital amplifier to receive a digital audio signal from the portable multimedia device and to digitally process and output the received digital audio signal to a speaker unit; and
a battery to supply electric power to at least one of the digital amplifier and the portable multimedia device.

2. The portable speaker of claim 1, wherein the battery always supplies the electric power to the portable multimedia device when the portable speaker is connected to the portable multimedia device.

3. The portable speaker of claim 1, wherein the battery supplies the electric power to the portable multimedia device only when an internal battery of the portable multimedia device is fully discharged and the portable speaker is connected to the portable multimedia device.

4. The portable speaker of claim 1, further comprising:
a virtualizer to provide a sound field effect to the audio signal; and
a dynamic range controller to prevent a clipping of the audio signal.

5. A portable speaker unit useable with a multimedia device, comprising:
a processing unit to process a digital audio signal received from the multimedia device and to output an audio analog signal corresponding to the received digital audio signal;
at least one speaker to receive the audio analog signal from the processing unit and to output sound corresponding to the audio analog signal; and
a battery unit to supply electric power to at least one of the processing unit and the multimedia device.

6. The portable speaker unit of claim 5, wherein the processing unit comprises:
a virtualizer unit to provide a sound field effect to the digital audio signal received from the multimedia device and to output the digital audio signal having the sound field effect;
a dynamic range controller unit to receive the digital audio signal having the sound field effect output from the virtualizer, to control a dynamic range of the digital audio signal having the sound field effect to prevent the signal from clipping, and to output a digital output signal; and
a digital amplifier unit to receive the digital output signal output from the dynamic range controller, and to output a demodulated audio analog signal to the at least one speaker.

7. The portable speaker unit of claim 6, wherein the digital amplifier unit converts the digital output signal received from the dynamic range controller into a pulse width modulation signal, amplifies the pulse width modulation signal to generate an audio analog signal, demodulates the audio analog signal, and outputs the demodulated audio analog signal to the at least one speaker.

8. The portable speaker unit of claim 7, wherein the digital amplifier unit comprises:
a converter to convert the received digital output signal into the pulse width modulation signal and to output the pulse width modulation signal;
a switching unit to receive the pulse width modulation signal output from the converter, to amplify the pulse width modulation signal to generate the audio analog signal, and to output the audio analog signal; and
a filter to receive the audio analog signal output from the switching unit, to demodulate the audio analog signal, and to output the demodulated audio analog signal to the at least one speaker.

9. The portable speaker unit of claim 6, wherein the digital output signal output from the dynamic range controller comprises a pulse code modulation signal having a low amplitude.

10. The portable speaker unit of claim 6, wherein the digital amplifier unit comprises an integrated circuit chip.

11. The portable speaker unit of claim 8, wherein the switching unit comprises a field effect transistor.

12. The portable speaker unit of claim 8, wherein the battery unit provides power to the switching unit.

13. The portable speaker unit of claim 5, further comprising:
at least one connecting unit to transmit the digital audio signal from the multimedia device to the portable speaker unit.

14. The portable speaker unit of claim 13, wherein the connecting unit comprises at least one of a connecting jack and a connecting dock.

15. The portable speaker unit of claim 5, further comprising:
at least one connecting unit to supply the electric power from the portable speaker unit to the multimedia device.

16. The portable speaker unit of claim 15, wherein the connecting unit comprises negative and positive poles and a ground unit to supply the electric power from the portable speaker unit to the multimedia device.

17. The portable speaker unit of claim 5, further comprising:
a multi-channel interface unit to transmit the digital audio signal from the multimedia device to the portable speaker unit and to supply the electric power from the portable speaker unit to the multimedia device.

18. The portable speaker unit of claim 17, wherein the multi-channel interface unit comprises:
a signal transmission pin to transmit the digital audio signal from the multimedia device to the portable speaker unit; and
a power transmission pin to supply the electric power from the portable speaker unit to the multimedia device.

19. A portable multimedia apparatus, comprising:
a multimedia unit, comprising:
a signal generating unit to decode audio data and to output a digital audio signal corresponding to the decoded audio data, and
an internal battery to provide electric power to the signal generating unit; and
a removable portable speaker unit, comprising:
a processing unit to process the digital audio signal output from the signal generating unit and to output an audio analog signal corresponding to the digital audio signal,
at least one speaker to receive the audio analog signal output from the processing unit and to output sound corresponding to the audio analog signal, and
a battery unit to supply electric power to at least one of the processing unit and the signal generating unit.

20. The portable multimedia apparatus of claim 19, further comprising:
a multi-channel interface unit to transmit the digital audio signal from the signal generating unit to the processing unit and to supply the electric power from the battery unit to the signal generating unit.

21. A portable multimedia apparatus, comprising:
a multimedia device, comprising:
a signal generating unit to decode audio data and to output a digital audio signal corresponding to the decoded audio data, and
an internal battery to supply electric power to the signal generating unit; and
an external battery pack to supply electric power to the portable multimedia device, comprising:
at least one speaker to output sound corresponding to the digital audio signal output from the signal generating unit, and
a battery unit to supply electric power to the signal generating unit of the portable multimedia device.

22. The portable multimedia apparatus of claim 21, wherein the internal battery supplies the electric power to the signal generating unit until the internal battery is discharged, and then the battery unit supplies the electric power to the portable multimedia device thereafter.

23. The portable multimedia apparatus of claim 21, further comprising:
a multi-channel interface unit to transmit the digital audio signal from the portable multimedia device to the external battery pack and to supply the electric power from the external battery pack to the portable multimedia device.

24. The portable multimedia apparatus of claim 21, wherein the external battery pack recharges the internal battery by transmitting electric power thereto.

25. A method of providing electric power to a portable multimedia device, comprising:
supplying the electric power to the portable multimedia device from an internal battery thereof while the internal battery contains a charge; and
supplying the electric power to the portable multimedia device from a portable external speaker based on the charge remaining in the internal battery.

26. The method of claim 25, further comprising:
recharging the internal battery of the portable multimedia device by providing electric power from the portable external speaker.

27. The method of claim 25, further comprising:
supplying the electric power to the portable multimedia device from a portable external speaker while maintaining a charge of an internal battery of the portable multimedia device.
